(19) United States
(12) Patent Application Publication
(10) Pub. No.: US 2013/0262586 A1
(43) Pub. Date: Oct. 3, 2013

(54) Method and System for Filtering Device Events by Social Graph

(71) Applicant: XTREME LABS, INC., Toronto (CA)

(72) Inventors: Boris Kai-Tik Chan, Toronto (CA); Kok King Tony Wong, Toronto (CA); Joshua Winters, Toronto (CA); Gregory Robert Burgoon, Toronto (CA)

(73) Assignee: XTREME LABS, INC., Toronto (CA)

(21) Appl. No.: 13/856,095

(22) Filed: Apr. 3, 2013

Related U.S. Application Data
(60) Provisional application No. 61/686,261, filed on Apr. 3, 2012.

(51) Int. Cl. H04L 29/08

(52) U.S. Cl. CPC H04L 67/22
USPC 709/204

(57) ABSTRACT

A method is provided for selectively displaying device events based on a user's social graph using a programmed computing device. Device events are aggregated from a plurality of applications on the device. The user's social graph is obtained and stored from a social network. The social graph has nodes that identify participants and in which the user is a participant. The device events are then parsed to identify participant references. At least one participant reference in a device event is matched to a relevant participant on the user's social graph. An interface is provided through which the participant can be displayed with the at least one device event matched to the participant.

### CROSS-REFERENCE TO RELATED APPLICATION

This application claims priority to U.S. patent application Ser. No. 61/686,261 for System and Method for Filtering Device Events by Social Graph, filed Apr. 3, 2012, the disclosure of which in hereby incorporated by reference in its entirety.

### FIELD OF INVENTION

The field of invention is generally related to mobile devices (e.g. smartphones), and more particularly relates to methods and systems for displaying device events on mobile devices.

### BACKGROUND OF THE INVENTION

Existing mobile devices (e.g. phones, smartphones, tablets and the like) have a multitude of standalone applications that provide connectivity and communications services to a user. Such services include e-mail, phone, text messaging service, instant messaging service, camera, etc. Each of these services is a silo, and data / device events captured by each of these applications is typically kept in a separate container. Thus, a user may have received a phone call and several text messages and e-mails and instant messages from a friend. If the user needs to check what communications he or she has had with that friend, the user needs to open each of the disparate applications and then visually go through a list which is often sorted based on time i.e. most recent events are at the top.

The above disparity is due to the fact that each of these applications has traditionally been independent and over time has been added to the smartphones one by one as technology improved. Thus we note that the earlier mobile phones only handled voice calls, then SMS was added, and later as data handling capability became possible on these devices multi-media, e-mail and instant messaging were added. Today we see many such standalone, poorly integrated applications on a smartphone. These can be thought of as silos, since the applications do not readily share information or interrelate with each other, even if the information they contain is frequently related or overlapping (e.g. multiple contact lists that must be re-entered or cut-and-pasted by the user in each separate application).

This poses a considerable challenge in terms of having a comprehensive and holistic view of the communications on a per person basis. Similarly, sorting events and communications based on which user may belong in which social category (e.g. communications with friends versus communications with colleagues versus communications with those that do not matter on a social basis e.g. a marketing call from the bank) is also not possible with the current implementations of the prior art.

This unsorted, unfiltered mass of communications is overwhelming and distracting to users. As a result, users may be inclined to lose interest and may overlook important communications or other device events. Improvements are needed so that users care about (and easily find meaning in) the communications received on their device, and so that users are able to quickly place incoming (or historical) communications in context.

Thus we note that prior art methods have inherent limitations. Accordingly, there is a need for providing an improved user experience by aggregating and reorganizing this device event data on a more personal basis. These shortcomings of the prior art are addressed in the present invention.

### SUMMARY OF THE INVENTION

The prior art deficiencies and other problems associated with silo applications on smartphones are addressed by the disclosed invention. Broadly speaking, the invention allows for aggregation of information and events from poorly integrated applications on a device and reorganization of this information on a more personal basis using social graph as a filtering mechanism.

In some embodiments, the functions may include providing e-mail, text messages, instant messages, phone logs, maps and directions, blogging, digital photography etc. in a people centric view. Instructions for performing these functions may be included in a computer readable storage medium or other computer program product configured for execution by one or more processors on the said device.

In summary, the invention aggregates the information and events from the poorly integrated applications on a device in a common database and supplements this with additional information acquired from the social graph of a user, and then using the social graph as a filter, re-organises this information and builds a people centric view of this aggregated data set. The social graph of a user can be acquired from the social network that a user prefers e.g. Facebook.

The device information and events are enhanced with additional information extracted from the social graph. The social graph is then also used for filtering this aggregated data set, offering a holistic way of organizing and presenting this information. This in turn improves user interaction and provides a new and unique way of interacting with these devices.

According to a first aspect of the invention, a method is provided for selectively displaying device events based on a user's social graph. The method uses a programmed computing device (e.g. a mobile device). Device events are aggregated from a plurality of applications on the device. The user's social graph is obtained from a social network and stored. The social graph has nodes that identify participants. (The user is a participant in the social network. The nodes represent participants connected to the user.) The device events are parsed to identify participant references. At least one participant reference in a device event is matched to a relevant participant on the user's social graph. An interface is provided through which the participant can be displayed with the at least one device event matched to the participant.

Preferably, the nodes include information, and the information from the user's social graph and the aggregated device events are displayable together by their relevant participant in the interface.

For example, the information typically includes a relationship between the participant identified in the node and the user.

In one embodiment, the interface includes a filter whereby the user can select to display only device events wherein the related participants have a particular relationship to the user (or display the device events by category of relationship to the user). For example, the filter may allow the user to select to only display device events related to the user's friends (or persons on the user's friend list) on the social graph. Device events by unrelated participants (or persons not on the user's social graph or not participating in the social network) may be (but are not necessarily) filtered out or blocked from immediate view.

Time may be another factor in the display. The interface may allow the user to select to display only device events within a particular timeframe (e.g. all device events related to a particular participant over the last week). Time-based conditions may also be incorporated in the filter (e.g. only show work-related device events during the work week).

The matching step may include matching by tags, email addresses, phone numbers, or keywords. The matching step may include matching by approximation or fuzzy logic.

The invention allows social graph information to be used to extend device event information and these can be aggregated together in the interface display. So for example, in one embodiment, the interface can display together:

(a) photographs associated with a participant from the participant's node on the social graph; and

(b) photographs associated with a device event associated with that participant.

The device events may include messages in multiple formats, in which case the messages related to the participant may be grouped and displayed together in the interface, irrespective of the message format. The messages may include email messages, text messages, instant messages, voice messages, phone messages, video messages, or audio messages.

Messages from the participant's social graph (e.g. communications between the user and the participant on the social network) may also be aggregated with the device event messages and the combined messages displayed together.

The device events may include locations. The locations may be linked to or displayed with a map in the interface.

The device event (or at least a preview thereof) is preferably displayable on the interface without the need to open or launch a related application.

The social graph is preferably stored on the device. It may be periodically refreshed, or refreshed on a demand (e.g. as-needed) basis. Portions of the social graph (e.g. specific to a participant node) may be updated separately where possible.

According to a second aspect of the invention, a programmed mobile device is provided for selectively displaying device events based on a user's social graph. The device has resident software. The device is programmed for aggregating device events from a plurality of applications on the device. The device obtains the user's social graph from a social network and stores it (locally or remotely). The social graph has nodes that identify participants. (The user is a participant in the social network. The nodes represent participants connected to the user.) The device is programmed to parse the device events to identify participant references. At least one participant reference in a device event is matched to a relevant participant on the user's social graph. An interface is provided on the device through which the participant can be displayed with the at least one device event matched to the participant.

Preferably, the social graph is (at least temporarily) stored on the mobile device. Alternatively, or in addition, the social graph may be remotely stored and accessible by query from the mobile device. Preferably, information from the social graph is stored in a superset with the aggregated device events.

### BRIEF DESCRIPTION OF THE FIGURES

FIG. 1 is a flow diagram representing a simplified version of an aspect of the present method (acquisition of social graph).

FIG. 2 is a flow diagram representing a simplified version of an aspect of the present method (acquisition/aggregation of device events).

FIG. 3 is a flow diagram representing a simplified version of an aspect of the present method (filtering device events by social graph).

FIG. 4 is a conceptual diagram of device events filtered based on relationships.

FIG. 5 is a conceptual diagram of a sample people-centric display of device events by participant in the social graph.

FIG. 6 is a schematic diagram of the notional software stack on a sample computing device (e.g. mobile device).

FIG. 7 is a flow diagram of an access procedure to obtain data from a social graph.

### DETAILED DESCRIPTION

Before embodiments of the invention are explained in detail, it is to be understood that the invention is not limited in its application to the details of the examples set forth in the following descriptions or illustrated drawings. The invention is capable of other embodiments and of being practiced or carried out for a variety of applications and in various ways. Also, it is to be understood that the phraseology and terminology used herein is for the purpose of description and should not be regarded as limiting.

Before embodiments of the software modules or flow charts are described in detail, it should be noted that the invention is not limited to any particular software language described or implied in the figures and that a variety of alternative software languages may be used for implementation of the invention.

It should also be understood that many components and items are illustrated and described as if they were hardware elements, as is common practice within the art. However, one of ordinary skill in the art, and based on a reading of this detailed description, would understand that, in at least one embodiment, the components comprised in the method and tool are actually implemented in software.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. Computer code may also be written in dynamic programming languages that describe a class of high-level programming languages that execute at runtime many common behaviours that other programming languages might perform during compilation. JavaScript, PHP, Perl, Python and Ruby are examples of dynamic languages. Additionally computer code may also be written using a web programming stack of software, which may mainly be comprised of open source software, usually containing an operating system, Web server, database server, and programming language. LAMP (Linux, Apache, MySQL and PHP) is an example of a well-known open-source Web development platform. Other examples of environments and frameworks using which computer code may also be generated are Ruby on Rails which is based on the Ruby programming language, or node.js which is an event-driven server-side JavaScript environment.

The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A device that enables a user to engage with an application using the invention, including a memory for storing a control program and data, and a processor (CPU) for executing the control program and for managing the data, which includes user data resident in the memory and includes buffered content. The computer may be coupled to a video display such as a television, monitor, or other type of visual display while other devices may have it incorporated in them (iPad). An application or a game or other simulation may be stored on a storage media such as a DVD, a CD, flash memory, USB memory or other type of memory media or it may be downloaded from the internet. The storage media can be inserted to the console where it is read. The console can then read program instructions stored on the storage media and present a user interface to the user.

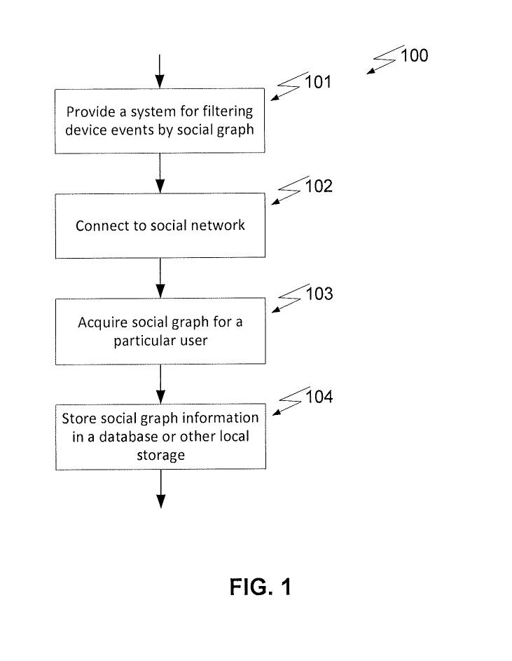

FIG. 1 is a simplified flow diagram of acquisition of a social graph for the present system of filtering/parsing. A system is provided for filtering device event information by social graph 101. In the preferred embodiment of the invention the system and method may be implemented on a smartphone and the social graph of the user acquired from a social network like Facebook.

The system connects to a social networking web-site 102. A social networking service is an online service or a platform or a website that provides the means for people to build their social networks reflecting their social relationships with other people. Typically a social network service consists of a representation of each person via a profile, each person's social connections and their interests. Today most social networking services are web-based and also provide means for people to interact with each other through e-mail, instant messaging, online chats etc. Social networking websites allow people to share ideas, activities, events, and interests within their individual networks.

Facebook, Twitter, LinkedIn and Google+ are examples the most popular social networking websites. Social networking websites share a variety of technical features. The most basic of these are visible profiles usually with a list of “friends” who are also users of the site. Some social networking websites allow people to upload pictures, add multimedia content to uniquely individualize the look and feel of their profiles. Facebook even allows people to enhance their profiles by adding modules or applications.

Profiles often have a section dedicated to comments from friends and other users. To protect user privacy, social networks typically have controls that allow users to choose who can view their profile, contact them, add them to their list of contacts, and so on.

The social graph is acquired for a particular user 103. In mathematics a graph is an abstraction for modeling relationships between things. A graph consists of nodes and edges, or things and the ways that these things relate to each other.

With the recent rise and proliferation of social networks, the social graph comes into the spotlight. A social graph is a representation of the interconnection of relationships in an online social network. A social graph is a mapping of people and how they are related or connected to other people. In a social graph, each person is a node. There is an explicit connection, if two people know each other, for example, two people can be connected because they work together or because they went to school together or because they are married. The links between people in social networks are of different types; and the different types of relationships can be a friend, a co-worker, a family member, a classmate, a schoolmate etc.

There may be at least two kinds of relationships; one-way relationships and two-way relationships. An example of a one-way relationship is a person subscribing or following a celebrity. In this kind of relationship, the person subscribing or following needs to start the relationship. An example of a two-way relationship is a person sending a “friend” request to another person. In a two-way relationship, the second person confirms the “friend” request to establish the relationship. Thus in a two-way relationship if the recipient of the “friend” request does not confirm this request, there is no relationship between the two people in the social graph.

It should be noted that the invention is not dependent on a live connection to the social network all the time to function; instead the social graph once acquired is harvested for information and this additional information may be used to supplement and augment the information on the device and then also used for filtering the device event information. In some embodiments, steps 102 and 103 may be repeated as often as necessary to keep the social graph up to date. Thus for example in one embodiment of the invention steps 102 and 103 may be repeated once a day while in another embodiment they may be repeated hourly. In this disclosure the term harvested implies extraction of relevant information from a larger set of data. Thus relevant information is extracted from the social graph since not all information contained in the social graph may be of use.

In one embodiment of the invention a social networking website provides a social graph; for example Facebook offers a social graph that represents people and the connections they have to other people or things that they may care about. Facebook offers a well documented and established API, the Graph API, which presents a simple, consistent view of the Facebook social graph, uniformly representing objects in the graph (e.g., people, photos, events, and pages) and the connections between them (e.g., friend relationships, shared content, and photo tags). The Graph API as such allows a developer/application to access all public information about an object. The Graph API allows an application to read properties and connections of the Facebook social graph. A developer can use the API to read specific fields, get pictures of any object, introspect an object for metadata and get real-time updates on any changes.

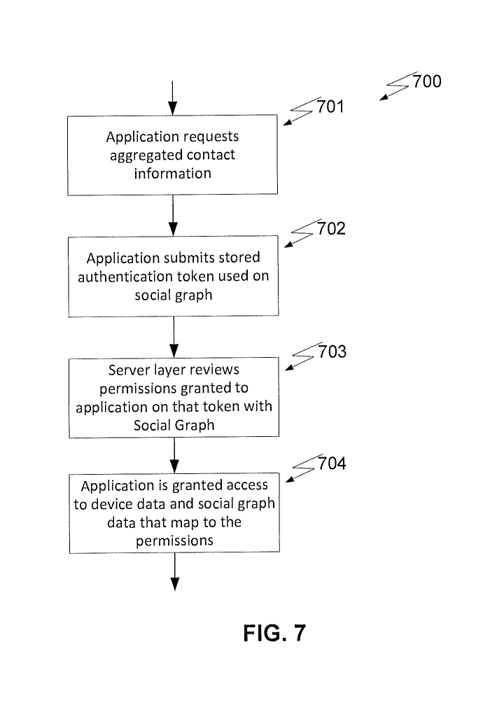

To get this context sensitive information about a user that is not publically available, a developer/application must first get their permission. To get this private information that is not publically available, an application must get an access token for the Facebook user. After obtaining the access token for the user, the application can perform authorized requests on behalf of that user by including the access token in the Graph API requests. The permissions process is described in more detail in FIG. 7.

Every object in the social graph has a unique ID. For example, with respect to Facebook, a developer can access the properties of an object by sending a secure request using the URL https://graph.facebook.com/ID. Additionally, people and pages with usernames can be accessed using their username as an ID. All responses to these requests are sent as JSON objects.

All of the objects in the Facebook social graph are connected to each other via relationships. A developer can examine the connections between objects using the URL structure https://graph.facebook.com/ID/CONNECTION_TYPE. The Facebook Query Language (FQL) object enables running FQL queries using the Graph API. Facebook Query Language enables a developer to use an SQL-style interface to query the data exposed by the Graph API. It provides for some advanced features not available in the Graph API, including batching multiple queries into a single call.

friendlist

Query this table to return any friend lists owned by the specified user.

friendlist_member

Query this table to determine which users are members of a friend list.

The social graph information is stored in a local database or other local data storage e.g. a file 104. The local data storage is such that it is easily accessible by other applications installed on a device. This may be achieved by providing an API to this aggregated information so that other applications may also easily access this information. Devices where invention can be advantageously implemented may include but not limited to an iPhone, iPad, smartphones, Android phones, personal computers e.g. laptops, tablet computers, touch-screen computers running any number of different operating systems e.g. MS Windows, Apple iOS, Linux, Ubuntu, etc.

In some embodiments, the device is portable. In some embodiments, the device has a touch-sensitive display with a graphical user interface (GUI), one or more processors, memory and one or more modules, programs or sets of instructions stored in the memory for performing multiple functions. In some embodiments, the user interacts with the GUI primarily through finger contacts and gestures on the touch-sensitive display. In some embodiments, the functions may include providing maps and directions, telephoning, video conferencing, e-mailing, instant messaging, blogging, digital photographing, digital videoing, web browsing, digital music playing, and/or digital video playing. Instructions for performing these functions may be included in a computer readable storage medium or other computer program product configured for execution by one or more processors.

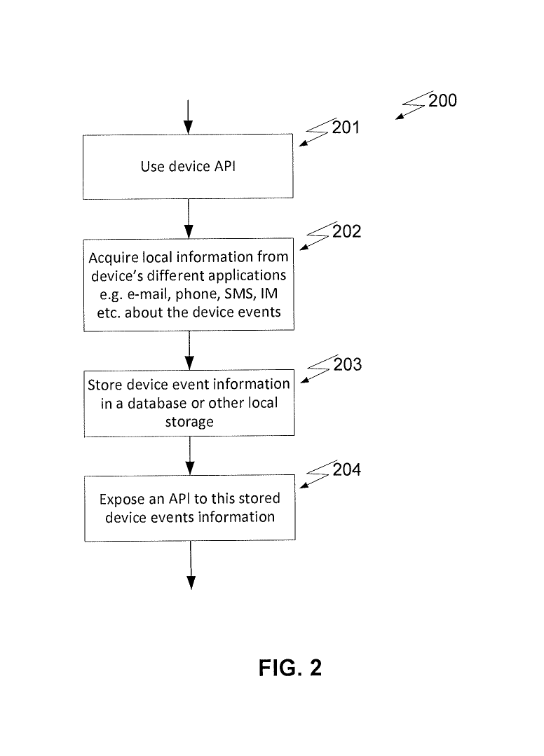

FIG. 2 is a simplified flow diagram of aggregation of device events. In one embodiment, the device operating system Application Programming Interface (API) (e.g. Google Android operating system API) 201 may be used to acquire device event information. Using said API local device event information is acquired from the diverse poorly integrated and/or silo applications on the device e.g. e-mail, phone (phone log), SMS, IM, contacts etc. 202.

The term silo application is used to describe an application not designed for reciprocal operation with other or related applications in the same environment.

Device events include but are not limited to call logs, which may include calls received, calls made, calls missed etc.; text messages received, sent etc. e-mails sent, received, drafts, etc. IM communications including conversations and files exchanged, camera photos and their related metadata e.g. geo-location, time and date, settings, subjects etc.; contacts. This list is exemplary and not limiting, in fact this list may include all or any other items that are obvious to persons skilled in the art.

Some examples of the Google Android API calls that may be used in this process to acquire the device events are given below:

TelephonyManager

Provides access to information about the telephony services on the device. Applications can use the methods in this class to determine telephony services and states, as well as to access some types of subscriber information. Applications can also register a listener to receive notification of telephony state changes.

SmsManager

Manages SMS operations such as sending data, text, and pdu SMS messages. Get this object by calling the static method SmsManager.getDefault( )

STATUS_ON_ICC_READ: Received and read text messages

STATUS_ON_ICCT_SENT: Stored and sent text messages

CallLog: The CallLog provider contains information about placed and received calls. Using this class and CACHED_NAME: The cached name associated with the phone number can be obtained.

CallLog.Calls: Contains the recent calls.

Device events information is stored in a database or other local storage on the device 203.

An API is exposed to this stored device events information 204. Other applications can then use this particular API to gain access to this stored information.

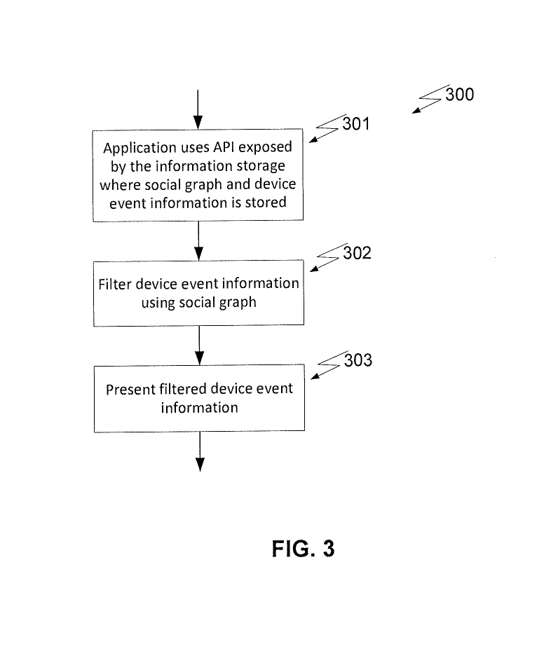

FIG. 3 shows one embodiment of the invention where a 3^{rd} party application uses the API exposed by the database or other local storage where device events information and social graph for the user are stored on the local device 301.

In one aspect of the invention, the information harvested from the social graph is part of the aggregated data set. The data acquired from the social graph is used to enhance the information that is available on the device. Information such as names, birthdays, anniversary, likes, other e-mail addresses and contact information, etc. that is acquired from the social graph complements the already available information in the device. This data set acquired from the social graph also provides an extra context e.g. friend lists, photos, etc. that doesn't exist on the device. Thus the aggregated information includes both the data set from the social graph as well as the data set from the device. When the final context/filtering is performed, the resultant combined information is much more useful since a more comprehensive data set has been used, one acquired from two different and divergent sources.

The device events information is filtered using the social graph of the user 302. The filtering may be based on the relationships defined in the social graph e.g. Facebook defines relationships like friends, family, colleagues, etc.

Filtered device event information (and supplemental information extracted from the social graph) is presented in a visual manner such that it is represented in a people centric view 303. A people centric view may be defined as one where the information is organized around people as opposed to a strictly time based view which is the usual prior art method at present.

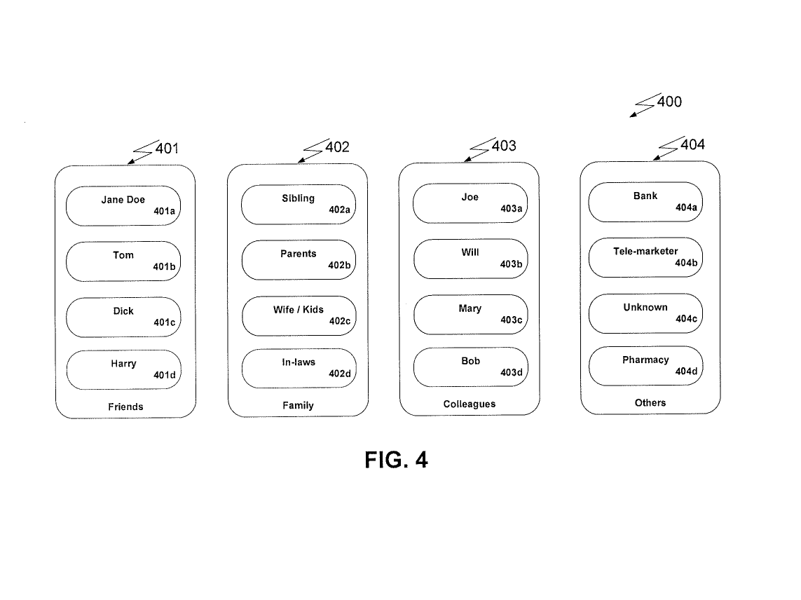

FIG. 4 shows a view of the device events information filtered based on the relationships obtained from the social graph of the user. The first set shows all the Friends 401 of the user, which may include members Jane Doe 401a, Tom 401b, Dick 401c and Harry 401d.

The second set shows all the Family 402 which may include members like Siblings 402a of the user, Parents 402b, Wife and Kids 402c and in-laws 402d in relationship to the user.

The third set shows all the Colleagues 403 of the user, which may include members Joe 403a, Will 403b, Mary 403c and Bob 403d.

The final and fourth set shows all “Others” 404 device event information for which there are no established relationships with the user. This set may have members like the e-mails from the Bank 404a, phone calls from a telemarketer 404b, calls from unknown numbers 404c and voice-mail messages from the pharmacy 404d.

Any of these sets of device event information may be filtered out either based on events or time. In one exemplary embodiment of the invention, Monday to Friday 9:00 am to 5:00 pm all device events are filtered out except those from Colleagues 403. While Monday to Friday 5:00 pm to 11:00 pm all device events are filtered out except those from Friends 401. Whereas on Saturdays and Sundays all device events are filtered out except those from Family 402. The device events from the group “Others” 404 may be filtered out all the time, to signify their lower relevance for the user.

In one embodiment of the invention a person may only belong to one of the sets 401 to 404. In another embodiment of the invention a person may belong to more than one sets e.g. a person may be a friend as well as a colleague of the user.

The logic of how people are related to each other may be derived from the social graph of the user. In one embodiment when the explicit relationship information may not be available from the social graph such information may be inferred from other information that may be available. For example the persons who may share the same domain in their e-mail addresses may be considered as colleague when such domain is not one provided by a free e-mail provider for example google.com or yahoo.com etc.

Relationships like family, friend, close friend, acquaintance etc. are inferred from the social graph, by association with a list, group or circle in a social graph, by presence on specific address book contact lists, and filtering can start/end with time and other means e.g. specific events like long weekend, holidays, birthdays etc.

The above sets are exemplary and not limiting and other embodiments of the invention may use any other relationships to categorize these sets of device event information.

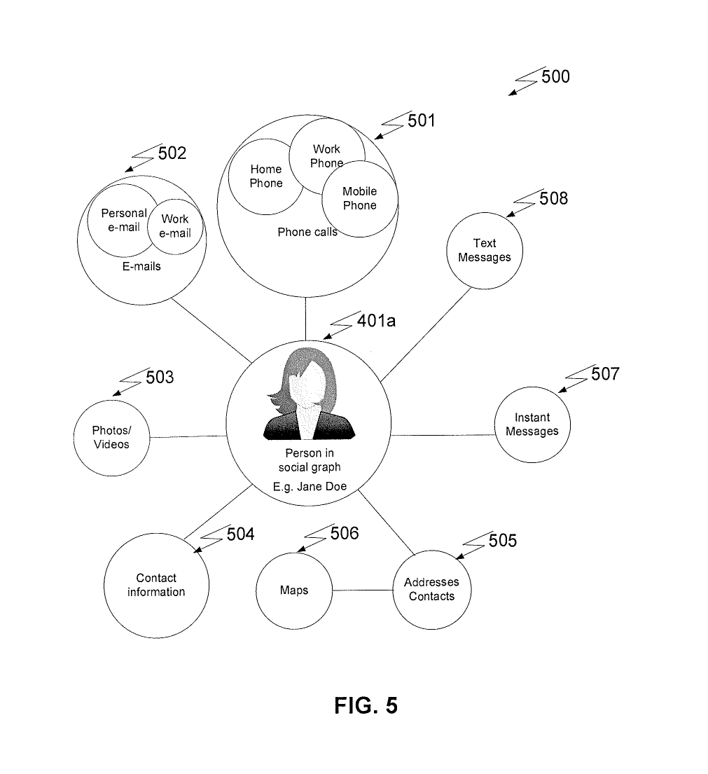

FIG. 5 shows one embodiment of the invention that shows a people centric view of the device events information filtered using the social graph. The device events information is organized around a person Jane Doe 401a whom we know from FIG. 4 is a friend of the user. All the device event information that was found on the user's device relating to Jane Doe 401a is presented in a holistic and visual way.

All the phone calls both to and from Jane Doe 501 whether they have been made or received at the home phone, work phone or mobile phone are presented together.

All the e-mails both to and from Jane Doe 502 whether they have been sent or received from personal e-mail account or work e-mail account are presented together.

All the photos/videos both sent to and received from Jane Doe or photos and videos that have her in them 503 are presented together.

All contact information items that relate to Jane Doe e.g. home phone number, office phone number, mobile phone number, work e-mail address, personal e-mail address, home address and office address etc. are presented together 504.

All addresses for example Jane Doe's home address, office address and cottage address etc. are presented together 505. All maps related to these addresses 505 are presented together 506. This may also include directions to these addresses from the user preferred starting address for example home address.

All instant messages (IM) sent and received from Jane Doe are presented together 507.

All text messages (e.g., SMS) and multimedia messages (e.g., MMS) that have been sent to or received from Jane Doe are presented together 508.

It should be noted that the social graph data is part of the aggregated data set. The data acquired from the social graph is used to enhance the information that is available in the device. Information like names, birthdays, anniversary, likes, other e-mail and contact information etc. that is acquired from the social graph complements the already available information in the device. This data set acquired from the social graph also provides an extra context e.g. friend lists, photos, etc. that may not exist on the device. Thus the aggregated information includes both the data set from the social graph as well as the data set from the device. When the final context/filtering is performed, it is much more useful since a more comprehensive data set has been used, one acquired from two different and divergent sources.

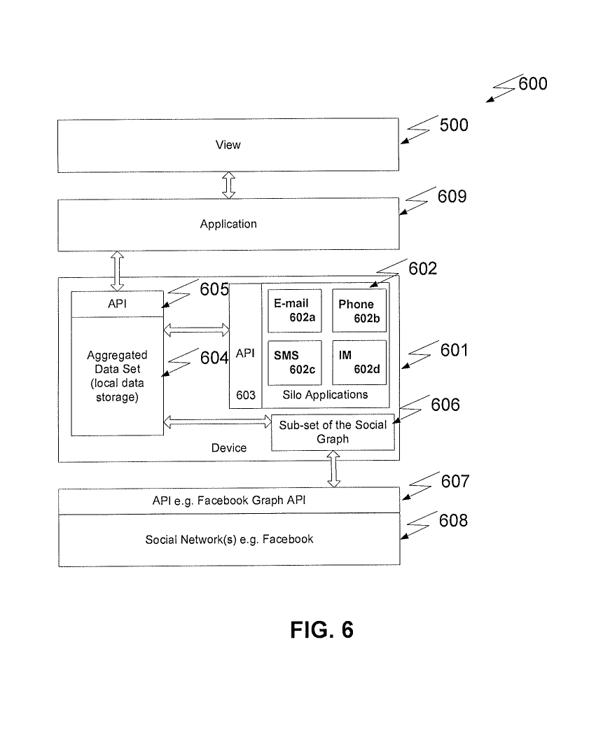

FIG. 6 shows one embodiment of the invention where device 601 which may have multiple silo applications 602 including for example e-mail 602a, phone 602b, SMS 602c and IM 602d installed on it.

Device API 603 is used to acquire the device event information from the different poorly integrated applications installed on the device. This extracted information is aggregated in say a database or other local data storage e.g. an XML file 604 on the device 601. A proprietary API 605 is exposed from this aggregated device event information.

A sub-set of the social graph 606 is extracted from the social networking website 608 using the API 607 provided by the social networking website. In one embodiment the information extracted from the social graph may also be used to supplement the information obtained from the device. In an alternate embodiment the entire social graph may be acquired from the social networking site. This aggregated data set may then be stored in the local data storage (e.g. a database) 604.

A third party application 609 connects to the proprietary API 605 and may make use of the aggregated data set 604 and the social graph 606. The aggregated data set (that includes the device event information and the information extracted from the social graph like birthdays, anniversaries, additional contact information, photos, etc.) is stored in specialized databases and/or cache storage and is exposed via custom content providers and interfaces (MDL) 605.

Said third party application 609 presents a people centric view 610 of the aggregated data set 604 using social graph 606 for filtering out the information that may not be relevant to the user.

The third party application 609 may either reside on the device itself or may be hosted outside of it. The third party application 609 uses the aggregated data set 604 to present a people centric view 500. The people centric view 500 of the device event information is shown in FIG. 5.

FIG. 7 shows the permissions process. In one embodiment of the invention the 3rd party application requests aggregated contact information 701. The application submits stored authentication token used on social graph 702. The server layer reviews permissions granted to 3rd party application on that token with social graph 703. The application is granted access to device data and social graph data that map to the permissions 704.

The aggregated data includes device event information acquired from the device and the social graph information acquired from the social network. Both these data sets come from two different sources and may have different permissions associated with each of them. Therefore in one embodiment of the invention, the permission structure may need to account for both local permissions (in order to access device event information) and social graph permissions (using the OAuth protocol, in order to access the social graph information in the social network); thus the application that requests access to the aggregated data needs to own the super set of both these permissions.

Facebook Platform uses the OAuth 2.0 protocol for authentication and authorization and supports two different OAuth 2.0 flows for user login: server-side (also known as the authentication code flow) and client-side (also known as the implicit flow). The server-side flow is used whenever an application needs to call the Graph API from its web server. The client-side flow is used whenever an application needs to make calls to the Graph API from a client, such as JavaScript running in a Web browser or from a native mobile or desktop application.

By default, the user is asked to authorize the application to access basic information that is available publicly or by default on Facebook. If an application needs more than this basic information to function, it must request specific permissions from the user. This is accomplished by adding a scope parameter to the OAuth Dialog request followed by comma separated list of the required permissions.

An application can access people and pages with usernames, where their username is an ID. Getting an access token for a user with no extended permissions allows an application to access the information that the user has made available to everyone on Facebook. If an application needs specific information about a user, like their email address or work history, it must ask for the specific extended permissions. The reference documentation for each Graph API object contains details about the permissions an application needs to access each connection and property on that object.

With a valid access token an application can invoke the Graph API by appending the access_token parameter to Graph API requests. If the user changes their password, the access token expires. An application can request a new access token by re-running the appropriate process.

It should be understood that although the term application has been used as an example in this disclosure but in essence the term may also imply to any other piece of software code where the embodiments of the invention are incorporated. The software application can be implemented in a standalone configuration or in combination with other software programs or integrated with an operating system and is not limited to any particular operating system or programming paradigm described here. Thus, this invention intends to cover all applications and user interactions described above as well as those obvious to persons skilled in the art.

The computer program comprises: a computer usable medium having computer usable program code, the computer usable program code comprises: computer usable program code for presenting graphically to the users options for scrolling via the touch-screen interface.

Several exemplary embodiments/implementations of the invention have been included in this disclosure. There may be other methods obvious to persons skilled in the art, and the intent is to cover all such scenarios. The application is not limited to the cited examples, but the intent is to cover all such areas that may be benefit from this invention.

The device may include but is not limited to a personal computer (PC), which may include but not limited to a home PC, corporate PC, a Server, a laptop, a Netbook, a Mac, a cellular phone, a smartphone, a PDA, an iPhone, an iPad, an iPod, an iPad, a PVR, a settop box, wireless enabled Blu-ray player, a TV, a SmartTV, wireless enabled Internet radio, e-book readers e.g. Kindle or Kindle DX, Nook, etc. and other such devices that may be used for the viewing and consumption of content whether the content is local, is generated on demand, is downloaded from a remote server where is exists already or is generated as a result. Source Device where content is located or generated and Recipient Device where content is consumed may be running any number of different operating systems as diverse as Microsoft Windows family, MacOS, iOS, any variation of Google Android, any variation of Linux or Unix, PalmOS, Symbian OS, Ubuntu or such operating systems used for such devices available in the market today or the ones that will become available as a result of the advancements made in such industries.

The intent of the application is to cover all such combinations and permutations not listed here but that are obvious to persons skilled in the art. The above examples are not intended to be limiting, but are illustrative and exemplary.

The examples noted here are for illustrative purposes only and may be extended to other implementation embodiments. While several embodiments are described, there is no intent to limit the disclosure to the embodiment(s) disclosed herein. On the contrary, the intent is to cover all alternatives, modifications, and equivalents obvious to those familiar with the art.

As can be seen from the foregoing description, the invention provides a system and method for filtering device event information aggregated from different silo applications installed on a device using social graph that improves user interaction and provides a new and unique way of interacting with these devices.

1. A method of selectively displaying device events based on a user's social graph, comprising using a programmed computing device to automatically carry out each of the following steps:
aggregating device events from a plurality of applications on the device;
obtaining and storing the user's social graph from a social network, the social graph having nodes that identify participants and in which the user is a participant;
parsing the device events to identify participant references;
matching at least one participant reference in a device event to a relevant participant on the user's social graph; and
providing an interface through which the participant can be displayed with the at least one device event matched to the participant.

2. The method of claim 1, wherein the nodes include information, and the information from the user's social graph and the aggregated device events are displayable together by their relevant participant in the interface.

3. The method of claim 2, wherein the information includes a relationship between the participant identified in the node and the user.

4. The method of claim 3, wherein the interface includes a filter whereby the user can select to display only device events wherein the related participants have a particular relationship to the user.

5. The method of claim 3, wherein the interface includes a filter whereby the user can select to only display device events related to the user's friends on the social graph.

6. The method of claim 1, wherein the interface allows the user to select to display only device events within a particular timeframe.

7. The method of claim 3, wherein the filter allows time-based conditions.

8. The method of claim 1, wherein the matching step includes matching by tags, email addresses, phone numbers, or keywords.

9. The method of claim 1, wherein the matching step includes matching by approximation or fuzzy logic.

10. The method of claim 1, wherein the interface displays together:
(a) photographs associated with a participant from the participant's node on the social graph; and
(b) photographs associated with a device event associated with that participant.

12. The method of claim 1, wherein the device events include messages in multiple formats, and wherein the messages related to the participant are grouped and displayed together in the interface, irrespective of the message format.

13. The method of claim 12, wherein the messages include email messages, text messages, instant messages, voice messages, phone messages, video messages, or audio messages.

14. The method of claim 12, wherein messages from the participant's social graph are aggregated with the device event messages and displayed together.

15. The method of claim 1, wherein the device events include locations, and wherein the locations are linked to or displayed with a map.

16. The method of claim 1, wherein the device event is displayable on the interface without the need to open or launch a related application.

17. The method of claim 1, wherein a preview of the device event is displayable on the interface without the need to open or launch a related application.

18. The method of claim 1, wherein the social graph is periodically refreshed.

19. A programmed mobile device for selectively displaying device events based on a user's social graph, the device having resident software programmed for:
aggregating device events from a plurality of applications on the device;
obtaining and storing the user's social graph from a social network, the social graph having nodes that identify participants and in which the user is a participant;
parsing the device events to identify participant references;
matching at least one participant reference in a device event to a relevant participant on the user's social graph; and
providing an interface through which the participant can be displayed with the at least one device event matched to the participant.

20. The device of claim 19, wherein the social graph is at least temporarily stored on the mobile device.

21. The device of claim 19, wherein the social graph is remotely stored and accessible by query from the mobile device.

22. The device of claim 19, wherein information from the social graph is stored in a superset with the aggregated device events.
